(19) United States
(12) Patent Application Publication
(10) Pub. No.: US 2006/0108798 A1
(43) Pub. Date: May 25, 2006

(54) End fitting for tubular member

(75) Inventor: Stuart Goodridge, Exeter (GB)

Correspondence Address: SEYFARTH SHAW LLP, 55 E. MONROE STREET, SUITE 4200, CHICAGO, IL, 60603-5803, US

(73) Assignee: Goodridge(UK) Ltd

(21) Appl. No.: 10/522,624

(22) PCT Filed: Jan. 16, 2004
(86) PCT No.: PCT/GB04/00216

§ 371 Date: Oct. 3, 2005

(30) Foreign Application Priority Data
Feb. 20, 2003 (GB) 03039187

(51) Int. Cl. F16L 33/00

(52) U.S. Cl. 285/256

(57) ABSTRACT

A fitting for connection to an end of a tubular member (204, 304), such as a hose or pipe, the fitting comprising a collar (202, 302) which is received over an outer surface of an end of the tubular member (204, 304), and a separate externally threaded sleeve (208, 308) which has an outside diameter which is larger than an internal diameter of the tubular member (204, 304), and is screwed into the tubular member (202, 304) to expand the tubular member and trap it between the collar (202, 302) and sleeve (208, 308).

This invention relates to end fittings for tubular members and particularly, although not exclusively, relates to improved end fittings for high pressure hydraulic hoses.

### BACKGROUND OF THE-INVENTION

Conventional hydraulic hose fittings are crimped or swaged to the end of a hydraulic hose. FIG. 1 shows a conventional swaged hose fitting comprising a collar 2 which fits over the outer surface of a hydraulic hose 4.

A hydraulic connector 6 is connected to the hose 4 by means of an integral sleeve 8 which is inserted into a bore 10 of the hose 4 until the connector 6 abuts an end of the hose 4. The position of the collar 2 is adjusted such that it overlaps the hose 4 and connector 6. The collar 2 is then forced radially inwardly in a direction D by means of a crimper or swager, until it assumes the orientation, illustrated in FIG. 1, in which the hose 4 is compressed between the collar 2 and sleeve 8.

Although such fittings are generally reliable, they require an expensive crimper or swager to assemble them. Furthermore, the bore 12 formed in the sleeve 8 is either smaller than the bore 10 of the hose 4 at the outset, or is reduced in diameter in the crimping or swaging process, so that the fitting restricts the maximum flow which could otherwise pass through the hose 4.

### STATEMENTS OF INVENTION

According to the present invention there is provided a fitting for connection to an end of a tubular member such as a hose or pipe, the fitting comprising a collar which is received over an outer surface of an end of the tubular member, and a separate externally threaded sleeve which has an outside diameter which is larger than an internal diameter of the tubular member, and which is screwed into the tubular member to expand the tubular member and trap it between the collar and the sleeve.

Preferably, the collar is closely received over an outer surface of the tubular member.

Preferably, an internal bore of the collar is cylindrical. Preferably, the internal bore is smooth, as opposed to having surface discontinuities such as serrations, ridges or barbs.

Preferably, the sleeve forms a thread in an internal wall of the tubular member as it is screwed in.

The thickness of a side wall of the sleeve may decrease towards its distal or leading end. For example, the distal end of the sleeve may be chamfered.

Preferably, the sleeve has an internal bore which is no smaller than an internal bore of the tubular member prior to insertion of the sleeve. Preferably, the tubular member is a hose. Most preferably the tubular member is a high pressure hydraulic hose.

Preferably, the sleeve is connected to a hydraulic connector at its end remote from a threaded end of the sleeve.

Preferably, the tubular member is formed from a polymer, such as Teflon.

Preferably, the tubular member comprises a resilient inner hose within a braided metal outer sheath.

Preferably, the thread on the threaded sleeve is 36 UNF or 28 UN on G-Line style pitch.

Preferably, the sleeve is provided with a secondary thread which engages in a corresponding thread formed on the collar. Preferably, the secondary thread is of larger diameter than the primary thread on the sleeve.

According to a second aspect of the present invention, there is provided a method of connecting a fitting to an end of a tubular member, the method comprising the steps of:

(a) fitting a collar over a free end of the tubular member;

(b) screwing a threaded sleeve of the fitting, which sleeve has an outside diameter larger than an internal diameter of the tubular member, into the tubular member, thereby expanding the tubular member and trapping it between the collar and the sleeve.

According to a third aspect of the present invention there is provided a fitting for connection to an end of a tubular member such as a hose or pipe, the fitting comprising a collar which is received over an outer surface of an end of the tubular member, and a separate sleeve which has an outside diameter larger than an internal diameter of the tubular member, and which is forced into the tubular member, thereby expanding the tubular member and trapping it between the collar and the sleeve.

Preferably, the sleeve is threaded and is forced into the tubular member by being screwed in. Preferably, the threaded sleeve forms a corresponding thread in an internal wall of the tubular member.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 shows a conventional swaged hose fitting;

FIGS. 2a to 2c show the principal steps in assembling a hose fitting in accordance with the present invention;

FIGS. 3a to 3c show the principal steps in assembling a hose fitting in accordance with an alternative embodiment of the present invention.

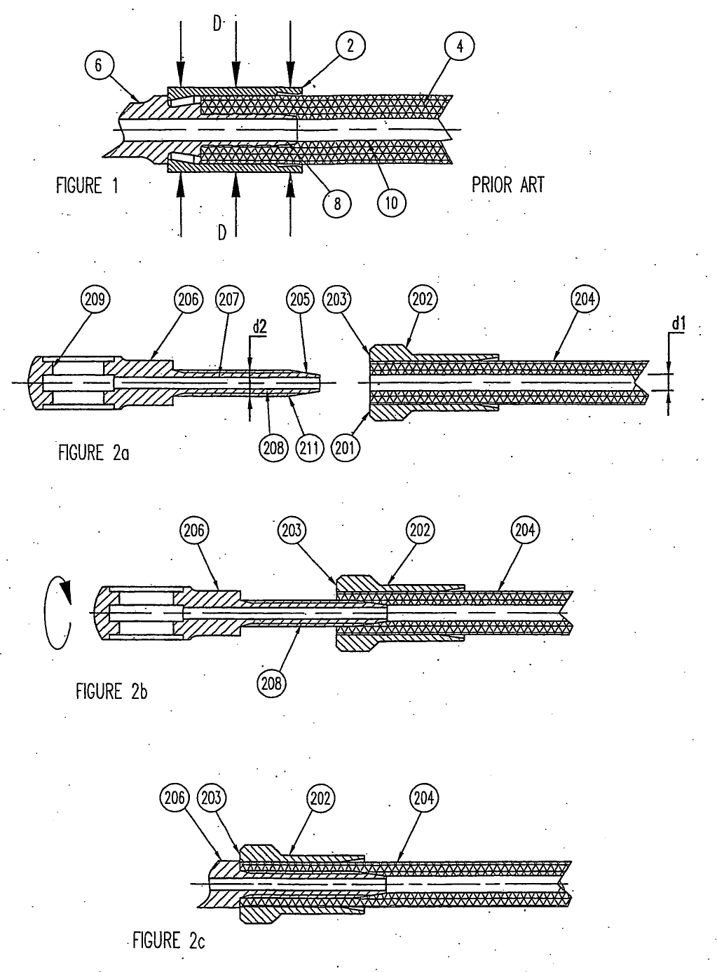

### DETAILED DESCRIPTION OF PREFERRED EMBODIMENTS

FIG. 2a shows a hose fitting for attachment to a hydraulic hose 204. The hose fitting comprises a cylindrical collar 202, and a hydraulic fitting 206 in the form of a banjo connector. The hydraulic fitting 206 is machined in one piece with an integral cylindrical sleeve or tail piece 208. The sleeve 208 is formed with an internal bore 207 which extends from a distal end 205 of the sleeve 208 into a larger bore 209 formed through the hose fitting 206. The sleeve 208 has an external thread 211 which may for example be 36 UNF or 28 UN on G-Line style pitch, and has a chamfered distal end 205.

In use of the hydraulic fitting, the collar 202 is pushed onto a free end 201 of the hose 204 until the free end 201 of the hose 204 is flush with a free end 203 of the collar 202. In order to aid in aligning the collar 202 with the hose 204, an annular flange (not shown), which projects radially inwardly from the collar 202, may be provided at the free end 203 of the collar 202. The hose 204 can then abut against the flange when the hose 204 is correctly positioned within the collar 202.

An internal bore d₁ of the hose 204, and the external diameter d₂ of the thread on the sleeve 208 are sized such that, as the sleeve 208 is screwed into the hose 204, it forces the hose 204 radially outwardly and cuts a corresponding thread in the hose 204.

FIG. 2b shows the sleeve 208 partially threaded into the hose 204, and FIG. 2c shows the sleeve 208 fully seated. As illustrated in FIG. 2c, as the sleeve 208 forces its way along the hose 204, the wall of the hose is forced radially outwardly against the collet 202, so that there is a gradual reverse crimping or swaging action, in which the wall of the pipe 204 is trapped between the sleeve 208 and the collar 202.

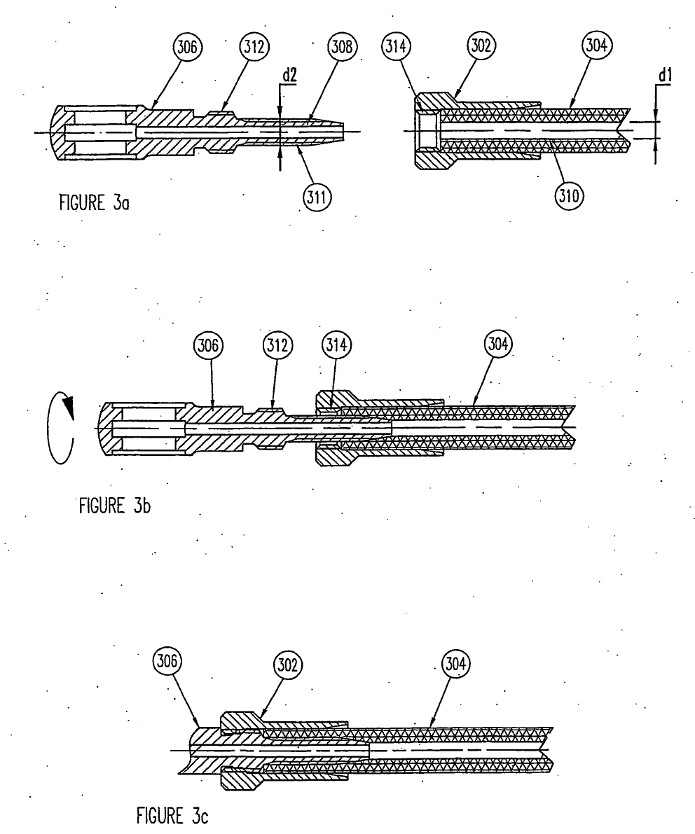

It has been found experimentally that a hose connection made in accordance with this embodiment of the invention is capable of withstanding a hydraulic pressure in excess of 8000 lb/in². However, in applications where a very small hydraulic fitting is required, or where consistent high pressures are encountered, the hydraulic fitting can be modified in the manner illustrated in FIGS. 3a to 3c. In this embodiment, a secondary male MS thread 312 is formed on a proximal end of a shortened sleeve 308. This secondary thread 212 is of larger diameter than the primary thread 311 formed on the sleeve 308. A corresponding female thread 314 is formed in a distal end of a modified collar 302. The principle of assembly of this embodiment is identical to the previous embodiment. However, after the primary thread 311 on the sleeve 308 is engaged for substantially three quarters of its length within the bore 310 in the hose 304, the secondary male thread 312 engages with the secondary female thread 314. This provides a direct threaded engagement between the collar 302 and the hydraulic fitting 306. FIG. 3b shows the point of engagement of the secondary male thread 312 with the secondary female thread 314 and FIG. 3c shows a fitting 306 screwed fully into the hose 304 and collar 302.

Although the specific embodiment relates to a hydraulic fitting in the form of a banjo connector, the present invention is applicable to connecting any type of fitting to a tubular member, such as a hose or pipe.

For example, it could be used in the assembly of a domestic plumbing fitting with appropriate selection of materials for the various components.

Preferably, the hose 204, 304 comprise a Teflon inner hose surrounded by a braided steel outer sheath. It is preferable that the material of the hose is able to be tapped by the primary thread 211, 311, but any material is contemplated for the hose. Also the hose may be of one piece construction or may comprise any number or combination of inner or outer elements. Furthermore, the primary thread 211, 311 formed on the sleeve 208, 308 may be of any suitable specification for the particular materials of the sleeve and hose. However, in experiments with Teflon hoses, a thread of 36 UNF or 28 UN on G-Line style pitch proved extremely effective and reliable.

1. A fitting for connection to an end of a tubular member, the fitting comprising a collar which is received over an outer surface of an end of the tubular member, and a separate externally threaded sleeve which has an outside diameter which is larger than an internal diameter of the tubular member, and which is screwed into the tubular member to expand the tubular member and trap it between the collar and the sleeve.

2-18. (canceled)
